(19) United States
(12) Patent Application Publication
(10) Pub. No.: US 2026/0347681 A1
(43) Pub. Date: Nov. 5, 2026

(54) GEOPOLYMER COMPOSITIONS AND METHODS WITH SOLUBLE SALTS

(71) Applicant: Schlumberger Technology Corporation, Sugar Land, TX (US)

(72) Inventors: Andrey Vladimirovich YAKOVLEV, Sugar Land, TX (US); Mark MEADE, Sugar Land, TX (US); Roderick PERNITES, Sugar Land, TX (US)

(21) Appl. No.: 19/143,920

(22) PCT Filed: Mar. 14, 2024
(86) PCT No.: PCT/US2024/019961

§ 371 Date: Jun. 27, 2025

Related U.S. Application Data
(60) Provisional application No. 63/452,130, filed on Mar. 14, 2023.
(60) Provisional application No. 63/603,911, filed on Nov. 29, 2023.
(60) Provisional application No. 63/605,727, filed on Dec. 4, 2023.

(51) Int. Cl. C09K 8/467; C04B 12/00; C04B 16/10; C04B 22/06; C04B 22/10; C04B 22/12; C04B 103/10; C04B 103/44; C04B 103/50

(52) U.S. Cl. CPC C09K 8/467; C04B 12/005; C04B 16/10; C04B 22/062; C04B 22/10; C04B 22/124; C04B 2103/10; C04B 2103/44; C04B 2103/50

(57) ABSTRACT

Described herein are compositions and methods or using soluble salts in geopolymer applications. The compositions include an aluminosilicate source, an activator, a carrier fluid, and a soluble salt additive. In some embodiments, the soluble salt additive is NaCl, LiCl, CaCl₂), or a combination thereof. The method includes preparing a geopolymer composition that is a pumpable mixture comprising an aluminosilicate source, an activator, a carrier fluid, and a soluble salt additive in a concentration selected to control an initial rate of a geopolymerization reaction. The geopolymer composition is placed in the subterranean well and allowed to harden into a solid geopolymer.

### CROSS REFERENCE TO RELATED APPLICATIONS

This patent application claims benefit of U.S. Provisional Patent Application Ser. No. 63/452,130 filed Mar. 14, 2023, U.S. Provisional Patent Application Ser. No. 63/603,911 filed Nov. 29, 2023, and U.S. Provisional Patent Application Ser. No. 63/605,727 filed Dec. 4, 2023, each of which is entirely incorporated herein by reference.

### BACKGROUND

This patent application relates to cementitious compositions and methods of using cementitious compositions. Specifically, this patent application addresses use of geopolymer precursors that include salt additives.

### DESCRIPTION OF THE RELATED ART

Geopolymers are a novel class of materials that are formed by chemical dissolution and subsequent recondensation of various aluminosilicate oxides and silicates to form an amorphous three-dimensional poly(silicon-oxo-aluminate) framework structure with empirical formula Mₙ{—(SiO₂)_{z}—AlO₂}ₙ, w H₂O, where M is a cation such as potassium, sodium or calcium, n is a degree of polymerization and z is the Si/Al atomic ratio that may be 1, 2, 3 or more.

The properties and application fields of geopolymers depend principally on their chemical structure, and more particularly on the Si/Al molar ratio. Geopolymers have been investigated for use in several applications, including as concrete systems within the construction industry, as refractory materials and as encapsulants for hazardous and radioactive waste streams. Geopolymers are recognized as being rapid setting and hardening materials that provide superior hardness and chemical stability, and represent an alternative to conventional cements for use in demanding applications.

Geopolymer synthesis involves the suspension of solid raw materials, such as the above-mentioned aluminosilicates, into a carrier fluid to form a slurry. The fluid-to-solid ratio of this slurry affects properties of the slurry such as, for example, its viscosity and hardening time, and the properties of the hardened material obtained from the same slurry. Methods and compositions are needed to provide gelation and thickening control, restoration, acceleration, and retardation in a geopolymer precursor that remains mixable and pumpable having controlled viscosity, and that is compatible with formation fluids and other fluids used in drilling and completion of wells and other subsea or subterranean, pipeline, or electrical applications.

### SUMMARY

Embodiments described herein provide a composition for a geopolymer precursor, comprising an aluminosilicate source; an activator; a carrier fluid; and a soluble salt additive in a concentration selected to control an initial rate of a geopolymerization reaction.

Other embodiments described herein provide a method, comprising preparing a pumpable geopolymer precursor comprising an aluminosilicate source, an activator, a carrier fluid, and a soluble salt additive in an amount selected to control an initial rate of a geopolymerization reaction; flowing the geopolymer precursor to a target location in a subterranean well; and hardening the geopolymer precursor into a solid geopolymer.

Other embodiments described herein provide a method, comprising preparing a pumpable geopolymer precursor containing an amount of a soluble salt additive selected to control thickening time of the geopolymer precursor; pumping the geopolymer precursor to a target location; and hardening the geopolymer precursor at the target location.

### BRIEF DESCRIPTION OF THE DRAWINGS

FIG. 1 is a graph showing setting results of a geopolymer precursor using potassium chloride as a salt additive according to one embodiment.

FIG. 2 is a graph showing setting results of a geopolymer precursor identical to the geopolymer precursor of FIG. 1, but using lithium chloride instead of potassium chloride as salt additive according to another embodiment.

FIG. 3 is a graph showing setting results of a geopolymer precursor identical to the geopolymer precursor of FIG. 1, but using sodium chloride instead of potassium chloride as salt additive according to another embodiment.

FIG. 4 is a graph showing setting results of a geopolymer precursor identical to the geopolymer precursor of FIG. 1, but using calcium chloride instead of potassium chloride as salt additive according to another embodiment.

FIG. 5 is a graph showing the effect of NaCl concentration on pH of 6.3 wt % sodium metasilicate solution.

### DETAILED DESCRIPTION

In the following description, numerous details are set forth to provide an understanding of the technology described. However, it may be understood by those skilled in the art that the methods described here may be practiced, in some cases, without some of the details, or in other combinations, and that numerous variations or modifications from the described examples may be possible.

In the development of any embodiments of the technology described herein, numerous implementation-specific decisions are made to achieve specific goals, such as compliance with system related and business related constraints, which will vary from one implementation to another. Moreover, such a development effort might be complex and time consuming but would nevertheless be a routine undertaking for those of ordinary skill in the art implementing this technology. In addition, the compositions used/disclosed herein can include components other than those specifically mentioned. In the summary above and this detailed description, any numerical values should be understood as approximate, as for example modified by the term “about” (unless already expressly so modified), due to variation that can come from measurement and formulation variance, among other sources. The term “about” can be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended to communicate that any concentration within the range, including the end points, is to be considered as usable and disclosed. For example, “a range of from 1 to 10” is to be read as indicating each possible number along the continuum between about 1 and about 10 can be used and is disclosed. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Salts used in geopolymer compositions may be effective to control polymerization of reactive materials in a geopolymer precursor while also providing rheology control and fluid compatibility in applications. Salts that do not participate in the geopolymerization reaction, but interact with the carrier fluid medium, and potentially the activator species in the geopolymer precursor mixture, can be used to accelerate or retard gelation, thickening time, and early compressive strength development of the geopolymer precursor. Sodium chloride (NaCl) and calcium chloride (CaCl₂)), added to a geopolymer precursor, can accelerate or retard the initiation of the geopolymerization reaction depending on concentration of the salt. It has been found that a concentration of sodium chloride that is below a concentration threshold will accelerate gelation, thickening time, and development of initial compressive strength and a concentration of sodium chloride that is above a concentration threshold will retard or slow gelation, thickening time, and development of initial compressive strength in geopolymer precursors. Various types of soluble, inorganic salts may provide these functions within a geopolymer precursor and application in a subterranean application such as a wellbore. The effect is complex, and the threshold is not a precise number, with dilution and interaction of sodium ions with reactive species in the geopolymer precursor, at least, driving the resulting reaction. Such salts that do not participate in a geopolymerization reaction can, however, be used as accelerators in an acceleration concentration, or as retarders in a retarding concentration, where the retarding concentration is higher than the acceleration concentration. In many cases, the threshold at which the action of the salt goes from acceleration to retardation, or vice versa, is about 5-10% by weight of the water used in the geopolymer precursor blend (“BWOW”). The exact threshold for a given blend will depend on many factors, such as the type of polymerization reactants and activators used, and the type of salt additives used.

The action of salt additives in geopolymer precursor blends enables controlling rheology and initial reaction rate of a geopolymerization reaction in a geopolymer precursor blend by using a selected amount of a salt additive. Whether the reaction is accelerated or retarded, and the extent of acceleration or retardation, can be targeted by including a selected amount of a salt additive in the geopolymer precursor blend. For example, a geopolymer precursor blend can be formed that uses an aluminosilicate source, an alkali activator, a carrier fluid, and a salt additive in an acceleration concentration to cause accelerated reaction of the geopolymer precursor blend. In other cases, a geopolymer precursor blend can be formed that uses an aluminosilicate source, an alkali activator, a carrier fluid, and a salt additive in a retardation concentration to cause slowed reaction of the geopolymer precursor blend. Acceleration of the reaction typically causes shortening of gelation and thickening time of the geopolymer precursor blend, and retardation typically causes lengthening of gelation and thickening time. By retarding the geopolymerization reaction, for example, the geopolymer precursor can remain pumpable and flowable for a longer time to reach a target location for hardening the geopolymer. Conversely, by accelerating the geopolymerization reaction, the time for the geopolymer to develop compressive strength can be reduced so that subsequent activities can start sooner. The action of the salt additives does not substantially alter the final properties of the geopolymer after hardening, but does alter the initial rate of the geopolymerization reaction and the development of gelation, thickening time, and initial compressive strength.

The geopolymer formulations described herein involve the use of an aluminosilicate source and an alkali activator in an aqueous carrier fluid, along with the salt additives mentioned above. The materials can be added or mixed in any order, and a single salt accelerator or a mixture of salt accelerators can be used.

Examples of aluminosilicate sources from which geopolymers may be formed include (but are not limited to) ASTM type C fly ash, ASTM type F fly ash, ground blast furnace slag, ground granulated blast furnace slag (GGBS), calcined clays, partially calcined clays (such as metakaolin), aluminum-containing silica fume, natural aluminosilicate, synthetic aluminosilicate glass powder, zeolite, scoria, allophone, bentonite, red mud, calcined red mud and pumice. These materials contain a significant proportion of an amorphous aluminosilicate phase, which reacts in strong alkaline solutions. The more common aluminosilicates are fly ash, metakaolin and blast furnace slag. Mixtures of two or more aluminosilicate sources may also be used if desired. In addition, alumina and silica may be added separately, for example as a blend of bauxite and silica fume. In another embodiment, the aluminosilicate component comprises a first aluminosilicate binder and optionally one or more secondary binder components which may include ground granulated blast furnace slag, Portland cement, kaolin, metakaolin or silica fume.

The alkali activator may be an alkali metal hydroxide, an alkaline-earth metal hydroxide, or combinations thereof. Alkali metal hydroxides may be sodium or potassium hydroxide. Alkaline-earth metal hydroxides may be calcium or barium hydroxide. These metal hydroxides may be in the form of a solid or an aqueous mixture. Also, the activator in another embodiment can be encapsulated. The activator when in solid and/or liquid state can be trapped in a capsule that will break when subjected to, for example, mechanical stress on the capsule, or coating degradation owing to temperature, chemical exposure or radiation exposure. Also, the activator when in solid and/or liquid state can be trapped in a capsule that will naturally degrade if made from a biodegradable or self-destructive material. Furthermore, the alkali activator when in liquid state may be adsorbed into a porous material and may be released after a certain time or due to a predefined event. The alkali activator can be generated in-situ by reaction of calcium hydroxide with sodium carbonate. The alkali activator may be present in the composition at a concentration between about 1M to 10M or between 3M and 6M.

Chlorides of alkali metals and alkaline earth metals can be used as salt additives to accelerate and retard geopolymerization reactions. The salt additives can be chlorides of Na, Li, K, Rb, Cs, Ca, Be, Ba, Mg, Sr, or a combination thereof. Thus, salts that can be used as additives to adjust the initial rate of geopolymerization reaction in a geopolymer precursor include NaCl (sodium chloride), LiCl (lithium chloride), KCl (potassium chloride), RbCl (rubidium chloride), CsCl (cesium chloride), CaCl₂) (calcium chloride), BeCl₂ (beryllium chloride), BaCl₂ (barium chloride), MgCl₂ (magnesium chloride), and SrCl₂ (strontium chloride). Fluorides and bromides of the above alkali metal and alkaline earth metal elements can also be used. A single salt additive can be used, or a mixture of salt additives can be used. In geopolymer precursors with slurry density below about 16.5 pounds per gallon (ppg), such as less than about 16.4 ppg, for example about 15.6 to 15.8 ppg, use of soluble salts in amounts not more than about 5% BWOW in a geopolymer precursor blend, for example about 1-4% BWOW, reduces setting time.

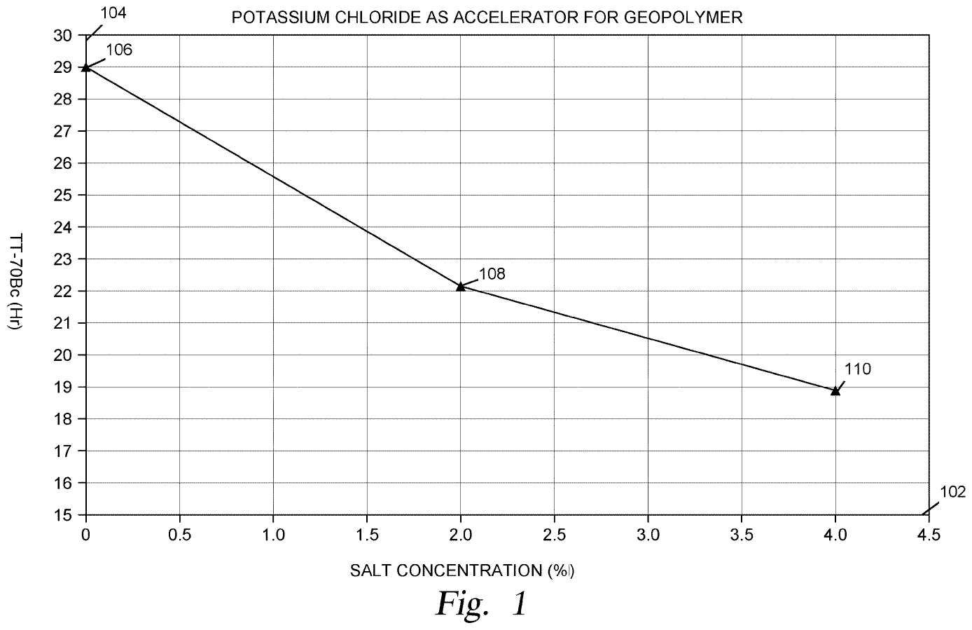

FIG. 1 is a graph 100 showing setting results of a geopolymer precursor using potassium chloride as a salt additive. This salt additive was added in different quantities to a geopolymer precursor made using ground granulated blast furnace slag (“GGBS”) as the aluminosilicate source and including 8%, by weight of the aluminosilicate source, of soda ash as activator. The geopolymer precursor also included 0.25%, by weight of the aluminosilicate source, diutan gum as viscosifier and 0.02 gallons per sack of propylene glycol as anti-foaming agent. Three geopolymer precursors were made, a first precursor using no salt additive, a second precursor using 2%, by weight of the aluminosilicate source, potassium chloride, and a third precursor using 4%, by weight of the aluminosilicate source, potassium chloride as salt additive.

The graph 100 has a first axis 102 that shows concentration of salt and a second axis 104 that shows setting time. The setting time was measured using an HPHT consistometer, with setting defined as reaching 70 Bc. The result with no salt is shown at point 106, the result with 2% salt is shown at point 108, and the result with 4% salt is shown at point 110. As shown in FIG. 1, setting time of the geopolymer precursors using salt as accelerator was significantly lower than the precursor using no salt.

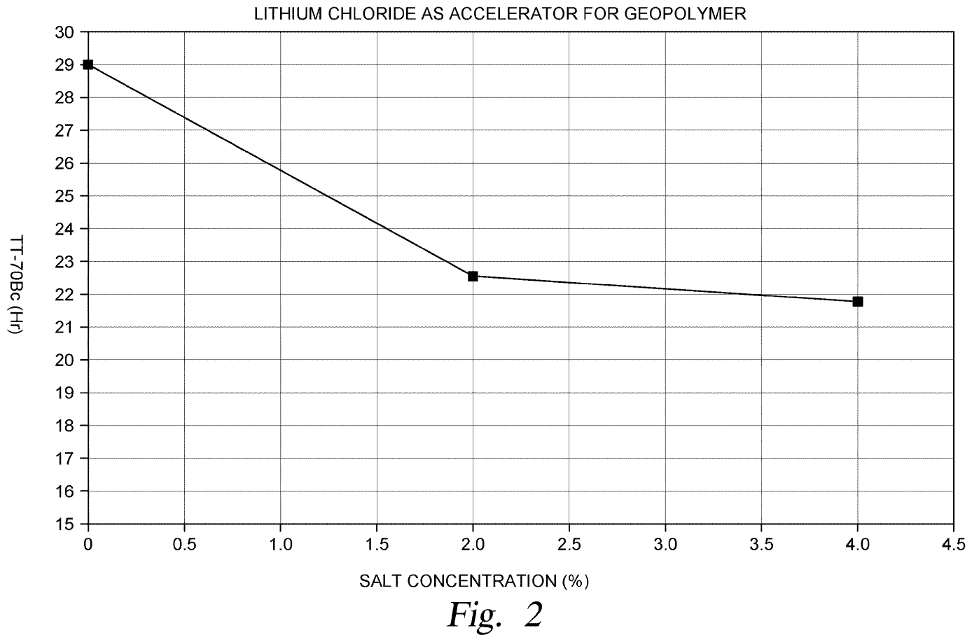

FIG. 2 is a graph 200 showing setting results of identical geopolymer precursors, this time using lithium chloride instead of potassium chloride as salt additive. The results in FIG. 2 similarly show significant reduction in setting time when using lithium chloride in a low concentration as salt additive.

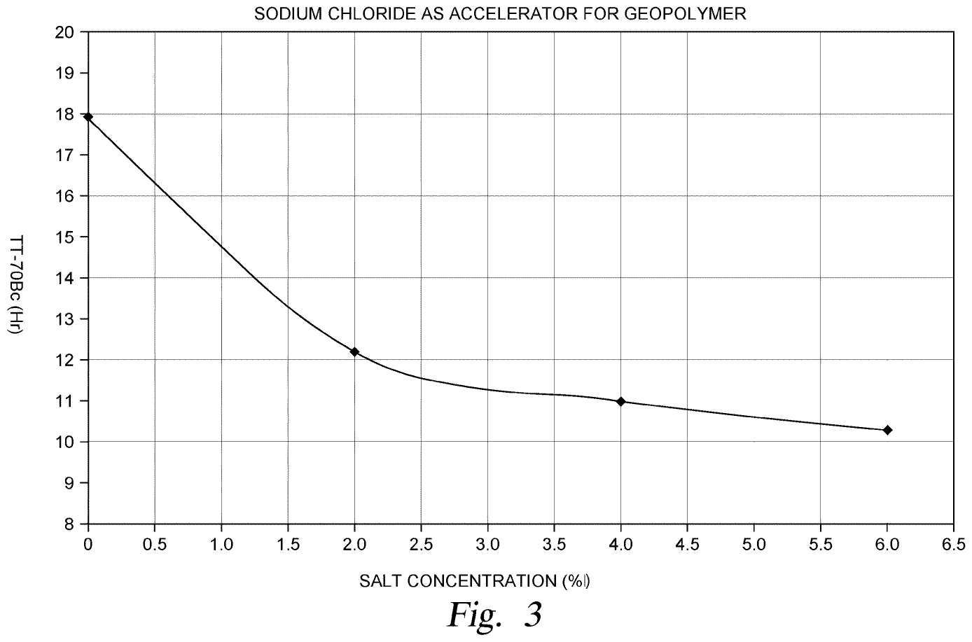

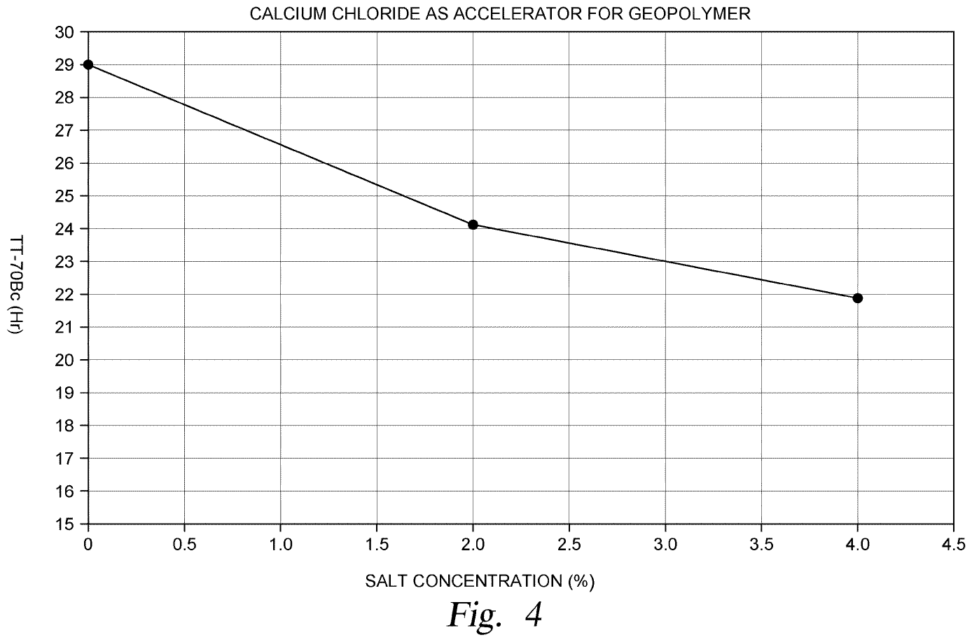

FIGS. 3 and 4 are similar graphs to the graphs 100 and 200 showing similar results for sodium chloride, in FIG. 3, and calcium chloride in FIG. 4. Notably, in this case, sodium chloride showed acceleration activity up to a concentration of 6%, by weight of the aluminosilicate source, indicating the range of accelerator activity for chloride salts of alkali metals and alkaline earth metals ranges at least up to a concentration of about 5% BWOW. The data shown in FIG. 3 were generated using a modified procedure that was not used to generate the data for FIGS. 1, 2, and 4. For FIG. 3, 10% soda ash was used and the consistometer readings were obtained by running the motor for 50 minutes, stopping the motor for 20 minutes, and then restarting the motor.

Table 1 shows properties of geopolymers made from a 12.5 ppg precursor using different amounts and types of salts as accelerators. The precursors were all disposed in a 2″×2″ cube mold and subjected to pre-curing conditioning for 30 minutes at 111 °F. The precursors were all then cured for 24 hours at 111 °F and ambient pressure to form geopolymers. Three samples of each precursor were cured. The compressive strength (in psi) of the geopolymers is shown in Table 1. In Table 1, the salt concentration is expressed based on weight of the aluminosilicate source.

TABLE 1
Geopolymers Made from Precursors Containing Soluble Salt

| Salt Conc., % | Comp. Strength 1 | Comp. Strength 2 | Comp. Strength 3 |
|---|---|---|---|
| 0 | 590 | 580 | 540 |
| 4, KCl | 860 | 780 | 720 |
| 4, LiCl | 1110 | 1160 | 1130 |

The data of Table 1 are consistent with the graphs of FIGS. 1-4 in showing faster setting, and higher early compressive strength, of geopolymers made from formulations using a low concentration of an alkali metal or alkaline earth metal chloride salt, or a mixture of such salts versus similar geopolymers made using no such salts.

Table 2 shows properties of two geopolymers made from a 15.5 ppg precursor, one using no salt accelerator, as control, and another using 2% by weight of aluminosilicate source, KCl as accelerator. Thickening time and compressive strength information for the two geopolymers is shown in Table 2. The thickening time test was performed by ramping temperature of the precursors to 110 °F and 500 psi over a duration of 15 minutes. The final geopolymers were made by curing the precursors for 24 hours in a 110 °F water bath. The precursors in Table 2 were made using GGBS and sodium silicate, with sodium hydroxide solution as activator to a solids volume fraction of about 42%.

TABLE 2
Properties of Geopolymers Made from
Precursors Containing Soluble Salt

| | Control | 2% KCl Accelerant |
|---|---|---|
| Time to 70 Bc | 23:33 | 13:49 |
| Time to 100 Bc | 24:32 | 14:08 |
| Compressive Strength (psi) | 1935 | 2315 |

The compressive strengths recorded in Table 2 are averages from four samples of each precursor cured to a final geopolymer and then tested for compressive strength. The data of Table 2, consistent with other data herein, show faster thickening and setting, and higher early compressive strength, of geopolymers made using a small amount of an alkali metal or alkaline earth metal chloride salt, or a mixture of such salts versus similar geopolymers made using no such salts.

NaCl and CaCl₂) have been evaluated and shown to be effective at temperatures ranging from 80 °F to 165 °F to suppress gelation and extend thickening time in a geopolymer precursor blend. Thickening time is usually expressed as time to reach 70 Bearden consistency units (Bc) as measured using a high-pressure, high-temperature consistometer. The concentration range of use for retardation is generally above about 5% BWOW, and may be up to 10% BWOW or 15% BWOW. Retardation of a geopolymer blend can be optimized by starting with a salt additive concentration of about 5% BWOW concentration of CaCl₂) or NaCl and adding concentration in increments of 1%. The choice to use either CaCl₂) or NaCl may depend on several slurry design factors such as SVF, other chemistries in the blend, and/or activator concentrations. Other soluble salts that do not participate in a geopolymerization reaction can also be used, alone or in combination with NaCl and/or CaCl₂).

NaCl may also be useful, in some cases, as a salt additive to control viscosity to achieve a mixable slurry as defined by obtaining less than 300 dial deflection reading at 300 rpms in a cuvette viscometer equipped with R1B1F1 rotor:bob:spring configuration immediately after mixing. Use of NaCl may be useful to control viscosity at temperatures ranging from 80 °F to 165 °F after duration of conditioning in pressurized or atmospheric consistometers to achieve slurry designs with Ty less than 75 lbf/100 ft2.

The reaction control action of NaCl, and other such salts, can help provide sufficient pumpability time for placement related to subterranean or subsea well construction and grouting applications of pipelines or electrical installations. The effect of salts in such applications can also be measured using HPHT consistometers in a hesitation thickening test. In such a test, the consistometer motor is turned on and off to simulate pumping schedules that may occur during placement related to subterranean or subsea well construction, grouting applications of pipelines, or electrical installations. The hesitation thickening test, or “go-no-go” test, can be used to find concentrations of salt additives for a geopolymer precursor blend that can be pumped and flowed to a target location. In many cases, spikes of less than 40 Bc in hesitation thickening tests identify geopolymer precursor blends that will remain flowable until the blend reaches the target location.

Following are examples of different inorganic salts that can be used with a geopolymer to provide gelation control, restoration, acceleration, and help address potential incompatibilities between spacers and geopolymers. Some of the examples may also provide improved mixability, viscosity control, and extend pumpability time in geopolymer applications. Some embodiments control geopolymer slurry pH levels

### Example 1

NaCl salt up to 25 wt % was used to adjust pH of geopolymer activator solutions. Sodium hydroxide and sodium silicate are most common geopolymer activators. Their molecules fully dissociate in the solution to form OH-ions, which determine pH of the fluid:

NaOH [symbol] Na⁺+OH⁻

NazSiO₃+H₂O [symbol] 2Na⁺+OH⁺HSiO₃⁻

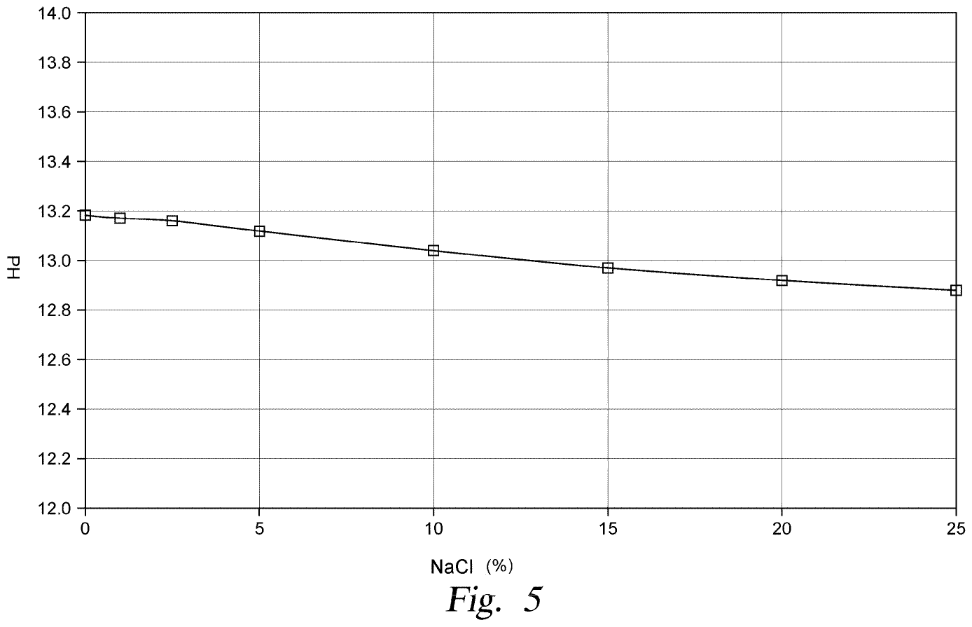

The addition of NaCl salt to these activator solutions adds Na⁺ ions, shifting these equilibrium reactions to the left and decreasing OH-concentration according to Le Chatelier's principle. FIG. 5 is a graph showing the effect of NaCl concentration on pH of 6.3 wt % sodium metasilicate solution. Observed pH in this example was reduced from about 13.2 to about 12.9 by adding 25% NaCl, by weight of the water of the solution. Reduced concentration of OH-ions reduces pH of the fluid, which reduces reaction rate of a geopolymer precursor blend. Thus, the common ion effect provides at least some of the observed effect of salt additives on a geopolymer reaction.

### Example 2

NaCl salt can be used as a geopolymer retarder. As kinetics of a geopolymerization reaction depends on pH, NaCl salt could be added to retard a setting time of geopolymer slurry (by decreasing fluid pH).

Table 3 shows 1.75 SG (14.5 lb/gal) GGBS-based geopolymer precursor recipes, one with no salt and two others with NaCl in different amounts. Blend 1 is a baseline with no salt. Blend 2 has 10% NaCl, by weight of water in the blend. Blend 3 has 15% NaCl, by weight of water in the blend. These blends show the effect of NaCl on the thickening time of these geopolymer slurries.

TABLE 3
Compositions of Blends 1-3

| Component | Blend 1 | Blend 2 | Blend 3 |
|---|---|---|---|
| Sodium | 6.6% BWOW | 6.6% BWOW | 6.6% BWOW |
| metasilicate | | | |
| Soda ash | 4.4% BWOW | 4.4% BWOW | 4.4% BWOW |
| Lime | 2.2% BWOW | 2.2% BWOW | 2.2% BWOW |
| Sodium chloride | | 10% BWOW | 15% BWOW |

Table 4 illustrates thickening time of Blends 1-3 measured in a pressured consistometer at 25 °C and 650 psi.

TABLE 4
Results of Blends 1-3

| | Blend 1 | Blend 2 | Blend 3 |
|---|---|---|---|
| Thickening time | 1:21 | 4:03 | 7:58 |
| (POD), hh:mm | | | |

As shown in Tables 3 and 4, the addition of NaCl to geopolymer precursor blends in a retardation amount increases thickening time of the blends.

Table 5 illustrates thickening time of some other geopolymer precursor embodiments. In Table 5, properties of blends 4-6 are shown. Blend 4 contains no soluble salt additive, while blends 5 and 6 contain sodium chloride. The compositions shown are expressed based on weight of the dry blend, prior to adding a carrier fluid, and are normalized to the quantity of aluminosilicate source (GGBS) used. In Table 3, amounts of GGBS, Welan gum, sodium carbonate, and sodium chloride are expressed based on amount of GGBS in the blends.

TABLE 5
Composition and Results of Blends 4-6

| Blend | 4 | 5 | 6 |
|---|---|---|---|
| BHST, °C | 45 | 45 | 45 |
| BHCT, °C | 45 | 45 | 45 |
| BHP, psi | 2000 | 2000 | 2000 |
| Ramp to T/P, min | 10 | 10 | 10 |
| Blend Specific Gravity | 1.75 | 1.75 | 1.75 |
| Blend SVF, % | 35.6 | 34.9 | 33 |

Blend Composition

| | | | |
|---|---|---|---|
| GGBS, % | 100 | 100 | 100 |
| Anti-foam, gal/sack | 0.02 | 0.02 | 0.02 |
| Welan gum, % | 0.02 | 0.02 | 0.02 |
| Sodium carbonate, % | 10 | 10 | 10 |
| Sodium Chloride, % | 0 | 3.5 | 15 |

Surface Rheology

| | | | |
|---|---|---|---|
| PV, cP | 38 | 33 | 32 |
| Ty, lbf/100 ft² | 6 | 6.7 | 6.8 |
| 10 sec gel | 5 | 6 | 6 |
| 10 min gel | 12 | 11 | 11 |

Downhole Rheology

| | | | |
|---|---|---|---|
| PV, cP | 69 | 90 | 53 |
| Ty, lbf/100 ft² | 24 | 22.5 | 13 |
| 10 sec gel | 16 | 14 | 10 |
| 10 min gel | 29 | 33 | 18 |

Thickening Time

| | | | |
|---|---|---|---|
| POD, hh:mm | 5:07 | 1:32 | 8:21 |
| 70 Bc, hh:mm | 7:14 | 4:38 | 9:56 |
| 100 Bc, hh:mm | 7:43 | 5:35 | 11:22 |

Compressive Strength

| | | | |
|---|---|---|---|
| 50 psi, hh:mm | 9:15 | 4:59 | 10:08 |
| 500 psi, hh:mm | 11:39 | 7:01 | 13:25 |
| 24 hr CS, psi | 1218 | 1393 | 1038 |

The results in Table 5 show the effect of different amounts of sodium chloride on a geopolymerization reaction. As shown in Table 3, a small amount of sodium chloride in the geopolymer precursor blend accelerates thickening time and early compressive strength development, while a larger amount has the opposite effect, retarding thickening time and early compressive strength development.

The effect of NaCl salt, and other soluble salts that do not participate in the geopolymerization reaction, on geopolymer precursors blends can be used to control viscosity of the blend, suppress gelation and increase static time during which the slurry remains pumpable. As shown above, adding salt can reduce the initial reaction rate, which in turn reduces the growth of viscosity of the blend, giving more time to place the precursor blend at a target location.

A soluble salt, as described herein, can also be added to a geopolymer precursor blend to improve compatibility of the blend with other fluids the blend might contact when being deployed to a target location. As demonstrated herein, soluble salts can affect the geopolymerization reaction that takes place in the blend. If a geopolymer precursor blend having no salt, or a low concentration of soluble salt, is pumped into a well that is drilled into a formation containing soluble salts, the geopolymer precursor blend may dissolve those salts, leading to a changing concentration of salt within the geopolymer precursor blend. The changing concentration of salt can change behavior of the geopolymerization reaction, unintentionally accelerating or retarding the reaction with potentially unintended and counterproductive consequences. A similar thing can happen when a geopolymer precursor blend having no salt, or a low concentration of soluble salt, contacts a spacer fluid that contains salt. The geopolymer precursor blend can absorb salt from the spacer fluid, leading to unintended results in the geopolymerization reaction. A concentration of the salt to be encountered in the formation or in the spacer fluid can be added to the geopolymer precursor blend to minimize changing salt concentration in the blend as the blend is pumped downhole. In such cases, using a stabilizing concentration of salt can improve results of a geopolymer application by minimizing changing concentration of salt in the geopolymer precursor.

A soluble salt additive having a common ion with the activator used in a geopolymer precursor blend can be used to control behavior of the activator in the blend. In one case, as noted above, adding such a salt additive can have the effect of reducing the activator concentration in the fluid phase of the precursor. In some cases, such a salt can be used to provide a solubility limit for the activator in the precursor that can be adjusted and/or controlled using temperature. For example, a solubility limiting quantity of a salt additive having a common ion with the activator in the precursor can be added to the precursor to adjust solubility of the activator in the carrier fluid phase of the precursor. In one case, the adjusted solubility limit can be below the concentration of activator in the carrier fluid phase, thus causing some activator to precipitate. In another case, the adjusted solubility can be near or above the concentration of activator in the carrier fluid phase. Where some activator precipitates, that activator becomes unable to catalyze a geopolymerization reaction, effectively reducing the amount of dissolved activator that can catalyze the reaction, and reducing the rate of the reaction. As temperature of the precursor rises, either through encountering elevated temperature surfaces within the formation or through heat of reaction, solubility of the activator in the carrier fluid phase typically increases so precipitated activator can return to solution and increase activation of the reaction. In this way, initial rate of the geopolymerization reaction can be limited by precipitating some activator until temperature of the geopolymer precursor rises.

Controlling initial reaction rate in a geopolymer precursor, which can minimize or control viscosity during placement of the precursor at a target location, as indicated by thickening time measurement, can be practiced in batch, semi-batch, or continuous preparation. Batches of geopolymer precursor containing soluble salts can be prepared, and thickening time of such batches measured to ensure the precursor remains pumpable during placement. If thickening time of batches increases, salt concentration of subsequent batches can be increased to return thickening time of the subsequent batches to a target. Likewise, if thickening time of batches decreases, indicating potential delay of setting, salt concentration of subsequent batches can be decreased to return thickening time of the subsequent batches to a target. In a semi-batch preparation case, a large batch of geopolymer precursor can be prepared with soluble salts at a concentration selected to target a thickening time for the precursor. Placement of the precursor can begin, for example by pumping the precursor to a target location, and while pumping, the precursor can be repeatedly sampled and thickening time measured. If thickening time of precursor remaining to be pumped is insufficient to allow time to place the remaining precursor at the target location, additional soluble salt can be added to slow thickening of the remaining precursor. In a continuous case, geopolymer precursor is continuously blended by flowing the aluminosilicate source, the activator, the carrier fluid, and the soluble salt into a mixing vessel, mixing the mixing vessel, and flowing geopolymer precursor out of the mixing vessel to a target location for setting. In such a process, the geopolymer precursor can be sampled from the mixing vessel or from piping that delivers the geopolymer precursor to the target location, and thickening time can be measured. If the measured thickening time is too high, the flow rate of soluble salt to the mixing vessel can be increased to return thickening time to a target. If the measured thickening time is too low, the flow rate of soluble salt to the mixing vessel can be decreased to return thickening time to a target.

Formation of a geopolymer may also involve a metal silicate. The metal silicate may be an alkali metal silicate such as sodium silicate, sodium metasilicate or potassium silicate. The sodium metasilicate may be present at a concentration between 0.02 kg/L and 0.2 kg/L, or between 0.05 kg/L and 0.1 kg/L. The SiO₂/Na₂O molar ratio may be less than or equal to 3.2. The SiO₂/K₂O molar ratio may be less than or equal to or less than 3.2. The metal silicate may be present in the composition at a concentration between about 0.1M and 5M, or between 0.5M and 2M. The metal silicates may be dry blended with the aluminosilicate source. Also, the metal silicate in another embodiment may be encapsulated.

Geopolymer precursors using soluble salt additives can be formulated to have slurry density from about 800 kg/m³ (6.7 lb/gal, SG 0.8) to about 2,500 kg/m³ (20.9 lb/gal, SG 2.5), for example from about 900 kg/m³ (7.5 lb/gal, SG 0.9) to about 2,300 kg/m³ (19.3 lb/gal, SG 2.3). Density modifiers can be used in the geopolymer precursors described herein to target a desired slurry density. Heavy particles may be added to increase precursor density. As noted above, in some cases, ultra-high densities can be achieved in a pumpable geopolymer precursor by pairing a density modified carrier fluid with solid insoluble density modifiers. The heavy particles typically may have densities exceeding 2 g/cm³, or more than 3 g/cm³. Examples include hematite, barite, ilmenite, silica and also manganese tetroxide commercially available under the trade names of MicroMax™ and MicroMax FF™. Mixtures of density modifiers can be used to target a particular slurry density or density profile. Thus, a geopolymer precursor as described herein can also include a non-soluble density modifier selected from the group consisting of hematite, barite, ilmenite, silica, manganese tetroxide, and combinations thereof.

The methods presented herein are applicable to the oilfield, for example during completion of the wellbore of oil or gas wells. To be used in oilfield applications, a pumpable precursor is formed where the geopolymer precursor is provided with an aqueous carrier fluid. Various additives may be added to the precursor, and the precursor may then be pumped into the wellbore. As is known in the industry, pumpability may be defined as a slurry consistency lower than about 70 Bc as measured in a laboratory using a high-temperature, high-pressure consistometer. The yield value (Ty) may be lower than about 100 lbf/100 ft². The precursor is then caused, or allowed, to set and harden in the well to provide zonal isolation in the wellbore. In other contexts, a geopolymer precursor can be prepared, placed at a target location, by pumping or any other suitable means, and caused, or allowed, to set and harden to provide the advantages of a geopolymer in any suitable application.

The geopolymer precursors described herein may be particularly useful where the precursor is intended to be prepared and/or deployed to a low temperature location, for example a location having temperature no more than about 160 °F or 100 °F. Because the low temperature will tend to slow setting of the geopolymer precursor, use of such precursors in low temperature locations, for example low temperature environments and/or subterranean locations, can lead to long setting and hardening times. Use of the salt additives herein in acceleration quantities can counteract the effects of low temperatures on geopolymer setting and hardening.

The aqueous carrier fluid can comprise sea water, fresh water, or a combination thereof. The aqueous carrier fluid can also comprise non-aqueous fluids that can be miscible or dispersible in the aqueous materials of the carrier fluid.

The geopolymer precursors described herein may have a multimodal particle-size distribution. For example, various solid materials that may be included in the geopolymer precursor, such as aluminosilicate materials, other silicate materials, and additives, can have different particle size distributions that may overlap to varying degrees to form a multimodal particle-size distribution.

The geopolymer precursors described herein may include other functional materials. For example, a geopolymer precursor may include a metal silicate such as sodium silicate, sodium, metasilicate, sodium disilicate, potassium silicate, or other alkali metal silicate, for example using alkali metals lithium, cesium, and/or rubidium. Alkali metal silicate may be present in the composition at a concentration between about 0.05M and 5M, or between 1M and 4M. The metal silicates may be dry blended with the aluminosilicate source. Also, the metal silicate may be encapsulated.

The geopolymer precursors described herein can be made in any order of mixing steps. For example, all dry ingredients can be blended to form a dry admixture, and then the carrier fluid can be added to the dry admixture (or vice versa) to make the geopolymer precursor. Thus, for example, a dry activator, an aluminosilicate source, and an accelerator can be made into a dry pre-blend, and then the dry pre-blend can be added to a carrier fluid (or the carrier fluid added to the dry pre-blend) to make a geopolymer precursor. In other cases, the accelerator can be added to the carrier fluid and dissolved, partially dissolved, and/or dispersed to form a mix fluid in which the accelerator is pre-hydrated, and then the mix fluid can be mixed with the other dry ingredients (aluminosilicate source, alkali activator, and any other additives) to make the geopolymer precursor. In another case, the dry alkali activator, accelerator, and other additives can be prepared in a pre-blend. In another case, the aluminosilicate source can be pre-blended with the accelerator, and a carrier fluid having an alkali activator, such a sodium hydroxide, in solution can be blended with the pre-blend. In another case, a pre-blend of accelerator and dry alkali activator can be added to the carrier fluid and dispersed and/or dissolved to form a mix fluid and then the aluminosilicate source can be added to the mix fluid to form the geopolymer precursor. In all these cases, a salt can be used as the accelerator, as described herein.

Other additives can be included in the geopolymer precursors described herein. Such additives may include activators, antifoam agents, defoamers, silica, fluid-loss control additives, viscosifiers, dispersants, expanding agents, anti-settling additives or combinations thereof. The fluid-loss control agent may comprise, or may be, a latex. The latex may be an alkali-swellable latex. The latex may be present in the geopolymer precursor compositions at a concentration between 0.02 L/L and 0.3 L/L (1 gal/bbl and 10 gal/bbl), or between 0.05 L/L and 0.15 L/L. Viscosifiers may comprise diutan gum having a molecular weight higher than about 1×10⁶. The diutan gum may be present at a concentration between 0.14 g/L and 1.4 g/L (0.05 lbm/bbl and 0.5 lbm/bbl). Other viscosifiers may comprise polysaccharide biopolymers including a polyanionic cellulose (PAC), welan gum, and/or carboxymethylcellulose (CMC), present at a concentration between 0.14 g/L and 1.4 g/L (0.05 lbm/bbl and 0.5 lbm/bbl). The molecular weight of the polysaccharide biopolymers may be between 100,000 and 1,000,000. Mixtures of any of these viscosifiers can also be used. Expanding agents may comprise calcium sulfate hemihydrate, metal oxides such as MgO or combinations thereof. The expanding agents may be present in the geopolymer precursor compositions at concentrations between 0.01 kg/L and 0.2 kg/L of slurry, or between 0.05 and 0.1 kg/L.

Carboxylic acids including glucoheptonic acid, tartaric acid, citric acid, glycolic acid, lactic acid, formic acid, acetic acid, proprionic acid, oxalic acid, malonic acid, succinic acid, adipic acid, malic acid, nicotinic acid, benzoic acid and ethylenediamine tetraacetic acid (EDTA) may be included in the geopolymer precursor compositions as retarders or disperants or both. Phosophoric acids may be present for the same purpose. Soluble carboxylate salts of these acids may also be employed. These materials may be present in the compositions at concentrations between 0.2 g/L and 20 g/L, such as between 0.5 g/L and 10 g/L, for example between 1 g/L and 5 g/L. Mixtures of these acids, salts, and acids with salts, can be used and can also be mixed with other retarders and dispersants described herein. Low molecular weight saccharides, such as glucose and sucrose, can also be used as retarders.

When various components are used with or within the geopolymer precursor, the particle sizes of the components may be selected and the respective proportions of particle fractions may be optimized in order to have a high Packing Volume Fraction (PVF) solids, and a mixable and pumpable precursor with a minimum amount of carrier fluid. As a result, the Solid Volume Fraction (SVF) of the resulting precursor may be 15-75%, 25-75%, 35-75%, or 50-60%.

The geopolymer precursor may be, or may include, a “trimodal” combination of particles: “large” particles (e.g., sand or crushed wastes with an average dimension between 100 and 1000 μm), “medium” particles, and “fines” (e.g., micromaterials such as micro fly ashes or micro slags with an average dimension between 0.2 and 10 μm). The geopolymer precursor may also be, or may include, a “tetramodal” combination of particles: “large” particles (average dimension between about 200 and 350 μm), “medium” particles (average dimension between about 10 and 20 μm), “fine” particles (average dimension of about 1 μm) and “very fine” particles (average dimension between about 0.1 and 0.15 μm). The geopolymer precursor may also include “very large” particles (e.g., glassmaker sand or crushed wastes with an average dimension larger than 1 mm). The “very fine” particles may be, or may include, latexes, pigments or polymer microgels whose particle sizes may be between about 0.05 and 0.5 μm. The geopolymer precursor may also include “ultra fine” particles, which may include colloidal silica or alumina with average particle sizes between about 7 and 50 nm. Geopolymer precursor compositions can include these particle size distributions.

The geopolymer precursor may further include one or more of the following materials: an aqueous direct emulsion of polymer comprising a betaine group, poly-2,2,1-bicyclo heptane (polynorbonene), alkylstyrene, crosslinked substituted vinyl acrylate copolymers, diatomaceous earth, natural rubber, polyisoprene, vinyl acetate polymer, polychloroprene, acrylonitrile butadiene polymer, hydrogenated acrylonitrile butadiene polymer, EPDM polymer, ethylene propylene polymer, styrene butadiene polymer, styrene/propylene/diene polymer, brominated poly(isobutylene-co-4-methylstyrene), butyl polymer, chlorosulfonated polyethylenes, polyacrylate, polyurethane, silicone polymer, brominated butyl rubber, chlorinated butyl rubber, chlorinated polyethylene, epichlorohydrin ethylene oxide copolymer, ethylene acrylate polymer, sulfonated polyethylene, fluoro silicone rubbers, fluoroelastomers, substituted styrene acrylate copolymers and bivalent cationic compounds. Any copolymer or multipolymers described above may be a block or non-block (e.g. random) polymer.

The methods described herein can be useful in completing subterranean wells, including oil and/or gas wells, water wells, geothermal wells, acid gas wells, and carbon dioxide injection or production wells. Placement of a geopolymer precursor in the portion of the wellbore to be completed is accomplished by means that are well known in the art of well completion. The geopolymer precursor is typically placed in an annular region surrounding a casing to prevent vertical communication through the annulus between the casing and the wellbore or the casing and a larger casing. The geopolymer precursor may be placed in a wellbore by circulation down the inside of the casing, followed by a wiper plug and a nonsetting displacement fluid. The wiper plug is usually displaced to a collar, located near the bottom of the casing. The collar catches the wiper plug to prevent overdisplacement of the geopolymer precursor and also minimizes the amount of the geopolymer precursor left in the casing. The geopolymer precursor is circulated up the annulus surrounding the casing, where it is allowed to harden. The annulus could be between the casing and a larger casing or could be between the casing and the borehole wall. Operations that use a geopolymer precursor described herein may cover only a portion of the open hole, or more typically up to a point inside the next larger casing or sometimes up to the surface. This method has been described for completion between formation and a casing, but can be used in any type of completion, for example with a liner, a slotted liner, a perforated tubular, an expandable tubular, a permeable tube and/or tube or tubing. In the same way, the methods of the present invention are useful in completing subterranean wells by reverse circulation.

The geopolymer precursor can also be used in remedial applications including “squeeze cementing” and “plug cementing,” including plug and abandonment operations. During “squeeze cementing” the geopolymer precursor may be forced through perforations or openings in the casing, whether these perforations or openings are made intentionally or not, to the formation and wellbore surrounding the casing to be repaired. The geopolymer precursor can be placed in this manner to repair and seal poorly isolated wells, for example, when either the original cement or geopolymer fails, or was not initially placed acceptably, or to shut off a producing interval. For “plug cementing,” the geopolymer precursor is placed inside the well by means that are well known in the art.

The geopolymer precursors described herein can also be used in surface applications, which can be new applications or remedial applications. The geopolymer precursor is generally mixed and placed at a target location, and then allowed to harden. Such applications can include construction applications.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

While the foregoing is directed to embodiments of the present invention, other and further embodiments of the present disclosure may be devised without departing from the basic scope thereof, and the scope thereof is determined by the claims that follow.

What is claimed is:

1. A composition for a geopolymer precursor, comprising:
an aluminosilicate source;
an activator;
a carrier fluid; and
a soluble salt additive in a concentration selected to control an initial rate of a geopolymerization reaction.

2. The composition of claim 1, wherein the soluble salt additive is selected from the group consisting of NaCl, LiCl, and CaCl₂).

3. The composition of claim 2, wherein the concentration is selected to target an amount of initial acceleration or retardation of the geopolymerization reaction.

4. The composition of claim 1, wherein the aluminosilicate source is selected from the group consisting of ASTM type C fly ash, ASTM type F fly ash, ground blast furnace slag, ground granulated blast furnace slag, calcined or partially calcined clay, aluminum-containing silica fume, natural aluminosilicate, synthetic aluminosilicate glass powder, zeolite, scoria, allophone, bentonite, red mud, calcined red mud, pumice, and a combination thereof.

5. The composition of claim 1, further comprising an antifoam agent, defoamer, silica, fluid-loss control additive, viscosifier, dispersant, expanding agent, anti-settling additive, density modifier, or combination thereof.

6. A method, comprising:
preparing a pumpable geopolymer precursor comprising an aluminosilicate source, an activator, a carrier fluid, and a soluble salt additive in an amount selected to control an initial rate of a geopolymerization reaction;
flowing the geopolymer precursor to a target location in a subterranean well; and
hardening the geopolymer precursor into a solid geopolymer.

7. The method of claim 6, wherein the soluble salt is selected from the group consisting of NaCl, LiCl, and CaCl₂).

8. The method of claim 6, wherein the concentration is selected to target an amount of initial acceleration or retardation of the geopolymerization reaction.

9. The method of claim 6, wherein the aluminosilicate source is selected from the group consisting of ASTM type C fly ash, ASTM type F fly ash, ground blast furnace slag, ground granulated blast furnace slag, calcined or partially calcined clay, aluminum-containing silica fume, natural aluminosilicate, synthetic aluminosilicate glass powder, zeolite, scoria, allophone, bentonite, red mud, calcined red mud, pumice, and a combination thereof.

10. The method of claim 6, further comprising adding to the pumpable geopolymer precursor an antifoam agent, defoamer, silica, fluid-loss control additive, viscosifier, dispersant, expanding agent, anti-settling additive, density modifier, or combination thereof.

11. The method of claim 6, further comprising, while flowing the geopolymer precursor to the target location, measuring a thickening time of the geopolymer precursor and adjusting the amount of the soluble salt additive to control the thickening time of the geopolymer precursor.

12. The method of claim 6, wherein the carrier fluid comprises seawater and the amount of the soluble salt additive is also selected based on concentration of salt in the carrier fluid.

13. The method of claim 6, wherein the amount of the soluble salt additive is selected to precipitate a portion of the activator.

14. A method, comprising:
preparing a pumpable geopolymer precursor containing an amount of a soluble salt additive selected to control thickening time of the geopolymer precursor;
pumping the geopolymer precursor to a target location; and
hardening the geopolymer precursor at the target location.

15. The method of claim 14, wherein the soluble salt additive is selected from the group consisting of NaCl, LiCl, and CaCl₂).

16. The method of claim 14, wherein the amount is selected to target an increased thickening time.

17. The method of claim 14, wherein preparing the pumpable geopolymer precursor comprises mixing together an aluminosilicate source, an activator, and the soluble salt additive to form a dry blend and adding a carrier fluid to the dry blend.

18. The method of claim 17, wherein preparing the pumpable geopolymer precursor further comprising adding to the dry blend an antifoam agent, defoamer, silica, fluid-loss control additive, viscosifier, dispersant, expanding agent, anti-settling additive, density modifier, or combination thereof.

19. The method of claim 14, further comprising, while pumping the geopolymer precursor to the target location, measuring a thickening time of the geopolymer precursor and adjusting the amount of the soluble salt additive to control the thickening time of the geopolymer precursor.

20. The method of claim 14, wherein the soluble salt additive is a fluoride, chloride, or bromide of an alkali metal or alkaline earth metal.
